(19) United States
(12) Patent Application Publication
(10) Pub. No.: US 2024/0232454 A9
(43) Pub. Date: Jul. 11, 2024

(54) TRANSITION STRUCTURE GENERATIONS FOR INTERNAL LATTICE STRUCTURE OF COMPUTER-AIDED DESIGN (CAD) OBJECTS

(71) Applicant: Siemens Industry Software Inc., Plano, TX (US)

(72) Inventors: Gaurav Ameta, Robbinsville, NJ (US); Wenjie Yao, Monmouth Junction, NJ (US); Elena Arvanitis, Somerville, NJ (US)

(73) Assignee: Siemens Industry Software Inc., Plano, TX (US)

(21) Appl. No.: 18/547,400

(22) PCT Filed: Feb. 25, 2021
(86) PCT No.: PCT/US2021/019569

§ 371 Date: Aug. 22, 2023

(51) Int. Cl. G06F 30/17

(52) U.S. Cl. CPC G06F 30/17

(57) ABSTRACT

A computing system may include a transition generation engine configured to access a computer-aided design (CAD) object comprising an external surface and an internal lattice structure represented through repeating unit cells of a lattice design, the internal lattice structure represented as a signed distance field (SDF). The transition generation engine may generate a transition structure for the CAD object within a transition distance from the external surface, including by applying a secondary SDF to modify a portion of the internal lattice structure within the transition distance from the external surface. The computing system may also include an object processing engine may be configured to process the CAD object comprising the transition structure (230) in support of physical manufacture of the CAD object.

### BACKGROUND

Computer systems can be used to create, use, and manage data for products, items, and other objects. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design, visualization, and simulated testing of product structures and product manufacture.

### BRIEF DESCRIPTION OF THE DRAWINGS

Certain examples are described in the following detailed description and in reference to the drawings.

FIG. 1 shows an example of a computing system that supports generation of transition structures for internal lattice structures of CAD objects.

FIG. 2 shows an example lattice transition generation for an internal lattice structure and external surface of a CAD object.

FIG. 3 shows an example generation of a transition structure through application of a secondary signed distance field.

FIG. 4 shows example processing of a CAD object that includes a generated transition structure to generate a hybrid faceted model for the CAD object.

FIG. 5 shows an example of a processing pipeline for generation and processing of transition structures for internal lattice structures of a CAD object.

FIG. 6 shows an example of logic that a system may implement to support generation of transition structures for internal lattice structures of CAD objects.

FIG. 7 shows an example of a computing system that supports generation of transition structures for internal lattice structures of CAD objects.

### DETAILED DESCRIPTION

Additive manufacturing (sometimes referred to as 3-dimensional or 3D printing) may be performed via 3D printers that can construct objects on a layer-by-layer basis. Through ongoing advances in additive manufacturing capabilities, manufacture of arbitrary and complex product designs has become increasingly possible. Within a given design space, previous manufacturing limitations have become overcome through additive manufacturing, and product designers now have increasing design freedoms that support design objectives and optimizations of manufactured objects, including through the design and manufacture of complex geometric structures. Accordingly, additive manufacturing can enable the manufacturing of parts with unique physical properties, specifically designed or controlled through the part's geometric structure, including the design of structures that form an internal geometry of an object or part.

For objects designed for construction via additive manufacturing, lattice structures can provide a light-weight and efficient mechanism to form internal geometries of object designs to meet certain physical, mechanical, or structural properties. A lattice structure may refer to any 2-dimensional (2D) or 3-dimensional (3D) combination of design elements that intersect or otherwise cross over each other with open spaces in between. In some instances, lattice structures may be formed, represented, instantiated, or otherwise implemented as repeating unit cells of a lattice design, and different instances of the repeating unit cells may be modified in a lattice structure, e.g., by similarity or transformation functions.

Lattice structures may also be referred to as internal lattice structures, as the geometry of lattice structures may form the internal geometry of a 3D object that has an external surface, thus infilling the 3D object. External surfaces may refer to any 2D or 3D surface, line, plane, curve, or body which encloses a lattice structure at least in part. In that regard, an external surface need not be an exterior surface a CAD object, but could be an internal body or sub-part that encloses (at least partially) a lattice structure. Example internal lattice structures include structured lattices (e.g., 2D or 3D grids with beams arranged in regularly spaced intervals) or bone-like lattices (e.g., non-linear or curved beams that intersect at irregular angles to mimic natural bone density patterns). Accordingly, internal lattice structures may be generated to infill a given CAD body, and such internal lattice structures may be designed to achieve various structural and mechanical properties.

While lattice structures constructed through additive manufacturing can provide efficient and cost-efficient capabilities to infill an object design, effective design of transitions between internal lattice structures and external surfaces of a CAD can be challenging. Trimming at lattice intersections with the external surface can be uneven or discontinuous, and stress concentrations at sharp junctures may inhibit structural integrity or cause undesired part behavior. Also, merging internal lattice structures with external surfaces can yield undesired object properties, and analysis of such lattice-to-boundary intersections can be challenging. Manual or uniform thickening of lattice geometry proximate to external surfaces may address some of these challenges, but often in an incomplete manner. For example, uniformly thickening diameters of lattice beams may not be possible for some orientations with respect to the external surface, particularly as junctions with external surfaces may be angled or otherwise result in object properties (e.g., stress concentrations) that fail to meet mechanical prerequisites, structural integrity thresholds, or other part requirements.

Manual modifications and blending of lattice structures at external surface intersections may be possible, but such an option is time-consuming, inefficient, and can introduce errors into object design processes. Moreover, object analyses and simulations (e.g. via finite element analysis) may cause parameter adjustments or optimizations to a lattice design. Continuous design optimizations (including to lattice layouts) may render any previously made manual modifications at lattice-to-surface intersections obsolete, irrelevant, or unusable. Accordingly, manually modifying lattice-to-surface transitions for each iteration of object simulations and analysis would require significant time and effort, and is impractical in modern product design contexts.

The disclosure herein may provide systems, methods, devices, and logic for generation of transition structures for internal lattice structures of CAD objects. As described in greater detail herein, lattice structures of CAD objects may be represented as signed distance fields (SDFs), which may also be referred to as signed distance functions. SDFs representations may increase the efficiency at which lattice designs are represented, instantiated, and processed, and may thus increase the computational speed and reduce memory requirements of computing systems that perform lattice infill generation and transformation processes. As also described herein, transition structures may be generated for portions of an internal lattice structure within transition zones, and generation of such transition structures may be performed through application of a secondary SDF on the SDF that represents such transition zone portions of the internal lattice structure.

Through generation of transition structures via secondary SDFs, the lattice transition generation features described herein may improve the efficiency and effectiveness of blending internal lattice structures to external surfaces. For example, distinct differentials of a secondary SDF (e.g., quadratic and linear-scaled differences) may be applied for different lattice portions in the transition zone. By doing so, improvements to the physical integrity at portions more proximate to external surfaces can be achieved while also linearly smoothing geometry transitions to non-transformed portions of an internal lattice structure. Moreover, generation of hybrid faceted models are described herein, which may include a combination of voxel-based and procedural-based faceted representations. Combinations of meshes generated in these different ways can improve the data efficiency at which CAD objects with internal lattice structures and transitions structures are represented as faceted meshes, which may reduce the memory footprint of computing systems for storing and processing CAD models. Accordingly, hybrid faceted models are described herein may reduce processing times to compute, analyze, or perform simulations for such CAD models.

These and other lattice transition generation features and technical benefits are described in greater detail herein.

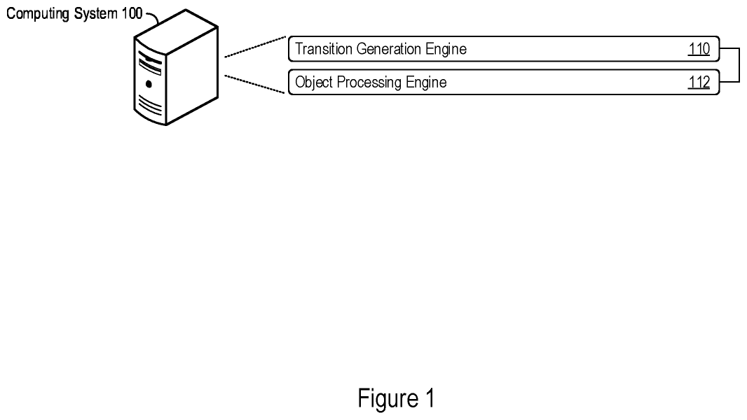

FIG. 1 shows an example of a computing system 100 that supports generation of transition structures for internal lattice structures of CAD objects. The computing system 100 may take the form of a single or multiple computing devices such as application servers, compute nodes, desktop or laptop computers, smart phones or other mobile devices, tablet devices, embedded controllers, and more. In some implementations, the computing system 100 hosts, instantiates, executes, supports, or implements a CAD application that provides any combination of the lattice transition generation features described herein.

As an example implementation to support any combination of the lattice transition generation features described herein, the computing system 100 shown in FIG. 1 includes a transition generation engine 110 and an object processing engine 112. The computing system 100 may implement the engines 110 and 112 (including components thereof) in various ways, for example as hardware and programming. The programming for the engines 110 and 112 may take the form of processor-executable instructions stored on a non-transitory machine-readable storage medium and the hardware for the engines 110 and 112 may include a processor to execute those instructions. A processor may take the form of single processor or multi-processor systems, and in some examples, the computing system 100 implements multiple engines using the same computing system features or hardware components (e.g., a common processor or a common storage medium).

In operation, the transition generation engine 110 may access a CAD object comprising an external surface and an internal lattice structure represented through repeating unit cells of a lattice design. The internal lattice structure may be represented as an SDF. In operation, the transition generation engine 110 may further generate a transition structure for the CAD object within a transition distance from the external surface, including by applying a secondary SDF to modify a portion of the internal lattice structure within the transition distance from the external surface. The applied secondary SDF may be quadratic for a first portion along the transition distance closest to the external surface and may be linear for a second portion along the transition distance further from the external surface than the first portion. In operation, the object processing engine 112 may process the CAD object comprising the transition structure in support of physical manufacture of the CAD object, doing so in any of the ways described herein.

These and other lattice transition generation features are described in greater detail next.

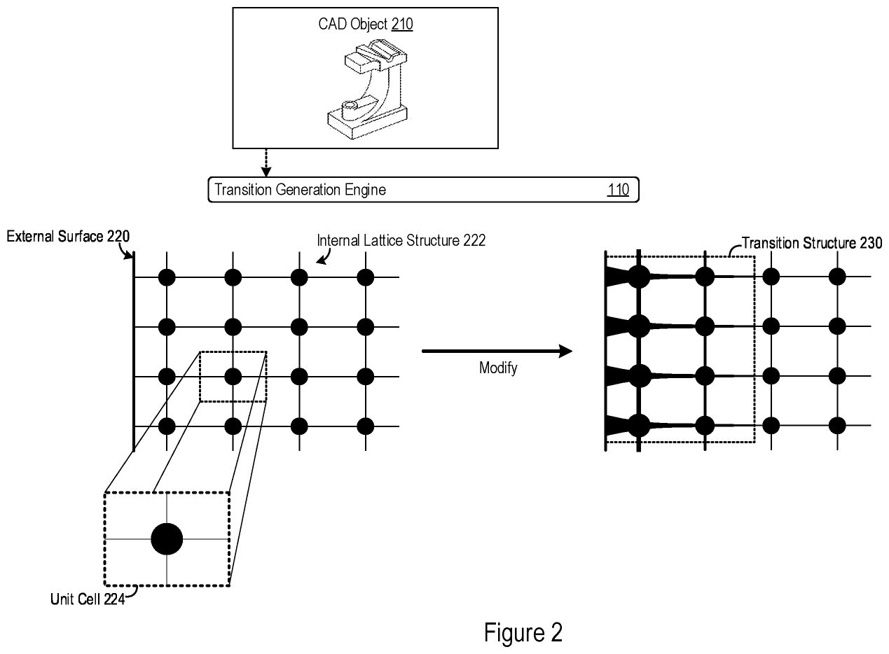

FIG. 2 shows an example lattice transition generation for an internal lattice structure and external surface of a CAD object. In the example shown in FIG. 2, the transition generation engine 110 accesses a CAD object 210. The CAD object 210 may be any type of digital representation of a 2D or 3D object, and may thus represent a geometry of the object in various ways. For example, the CAD object 210 may represent a 3D part that is to be manufactured via additive manufacturing, and thus design of the CAD object 210 (including lattice infills and lattice transitions to external surfaces) may be performed to produce specific physical and structural characteristics of a 3D part manufactured via the design of the CAD object 210.

Geometry of the CAD object 210 accessed by the transition generation engine 110 may be represented in various ways, including via combinations of different type of formats or techniques. For instance, faces or surfaces of the CAD object 210 may be represented as boundary representations, splines, or as faceted meshes, whether through triangles or other mesh primitives. The CAD object 210 may include any number of internal lattice structures to infill the design of a portion, sub-part, or element of the CAD object 210, and such internal lattice structures may be represented procedurally as SDFs. As such, internal lattice structures of the CAD object 210 need not be instantiated as expressly visibly 3D geometries, but SDF representations may provide an efficient mechanism to represent, store, access, instantiate, and process internal lattice structures.

In the example shown in FIG. 2, a portion of the CAD object 210 is depicted that includes an external surface 220 (e.g., of a CAD body or subcomponent surface). The depicted portion of the CAD object 210 also includes an internal lattice structure 222. For visual clarity, the external surface 220 and internal lattice structure 222 are illustrated in 2D for illustrative purposes. It is contemplated that the external surface 220 may be any 3D plane or surface of the CAD object 210 and the internal lattice structure 222 may be a 3D lattice design enclosed by (at least in part) by a 3D form of the external surface 220. As noted herein, the internal lattice structure 222 may be represented through repeating unit cells of a lattice design, and one example of an unit cell is shown as the unit cell 224 in FIG. 2.

The transition generation engine 110 may modify a portion of the internal lattice structure 222 to blend a repeating lattice design into an external surface. By doing so, the transition generation engine 110 may alter physical object characteristics of the modified portion, which may improve part performance and integrity. For example, the transition generation engine 110 may modify the structural integrity or mechanical properties of the modified lattice portion, doing so to release stress points, strengthen structural integrity, or achieve other optimization goals for a CAD object, which may then take effect in subsequently manufactured parts. In some implementations, the transition generation engine 110 may blend a selected portion of the internal lattice structure 222 with the external surface 220, e.g., by thickening the selected portion.

The specific portions of an internal lattice structure modified or transformed by the transition generation engine 110 to blend a lattice design with an external surface may be referred to as transition structures. As such, transition structures may be generated from a lattice design or internal lattice structure, doing so by modifying an initial repeating design of a lattice structure at portions of internal lattice structure proximate to the external surfaces that enclose the internal lattice structure. An example of a transition structure generated by the transition generation engine 110 is shown in FIG. 2 as the transition structure 230. In generating the transition structure 230, the transition generation engine 110 may leverage SDF implementations of the internal lattice structure 222 to modify a selected portion of the internal lattice structure 222. For example, the transition generation engine 110 may do so by applying a secondary SDF to the selected portion of an internal lattice structure 222 to modify the geometric structure of the selected portion and blend the lattice structure to an adjoining external surface.

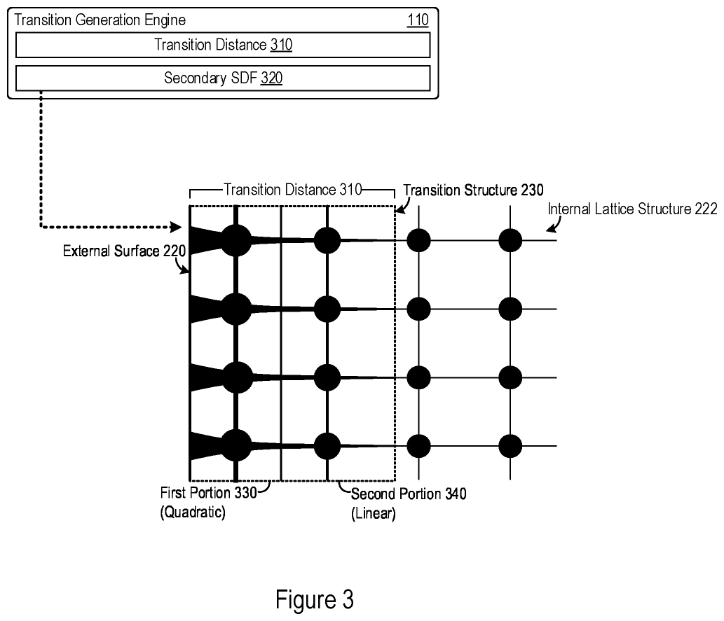

Example features of secondary SDF applications to generate transition structures are described next with reference to FIG. 3.

FIG. 3 shows an example generation of a transition structure through application of a secondary SDF. The transition generation engine 110 may generate transition structures according to any number of transition parameters, and transition parameters may comprise any element, constraint, geometry requirement, definition, or other attribute applicable to a transition structure. Transition parameters may be specified via user input or may be accessed, determined, extracted, calculated, created, or otherwise generated by the transition generation engine 110 itself.

As two examples of transition parameters shown in FIG. 3, the transition generation engine 110 may access a transition distance 310 and a secondary SDF 320. The transition generation engine 110 may access such transition parameters from user input, as predetermined system parameters, or as otherwise generated by the transition generation engine 110 itself from, for example, other user-specified inputs. Features of the transition distance 310 and secondary SDF 320 are described in turn.

The transition distance 310 may specify a threshold distance from external surfaces for which to modify an internal lattice structure into a transition structure. Transition distances may be specified as fixed values (e.g., a transition distance of 10.1 centimeters), as computational expressions (e.g., as 1% of the total width of a CAD body that encloses an internal lattice structure), as factors of the lattice design itself (e.g., as distance value of 4× lengths of the base unit cell of a lattice design from external surfaces), and more. Accordingly, the transition distance 310 may define or bound a region of an internal lattice structure proximate to external surfaces of a CAD object that the transition generation engine 110 can modify or transform into transition structures

Through the transition distance 310, the transition generation engine 110 may determine a specific portion of the internal lattice structure 222 to modify into a transition structure. Such determination of an internal lattice portion can be seen through the example in FIG. 3, and such a determined, selected, or apportioned region of an internal lattice structure may be referred to as a transition zone. That is, the transition zone may refer to a portion of the internal lattice structure 222 within the transition distance 310 from the external surface 220 that the transition generation engine 110 determines as a selected portion of the internal lattice structure to modify to form the transition structure 230. Portions of the internal lattice structure 222 not within the transition distance 310 from the external surface 220 (e.g., outside the transition zone) may be remain unmodified, as the transition generation engine 110 may determine not to modify such portions of the internal lattice structure 222 based on the transition distance 310. As such, the transition distance 310 may bound or define a transition zone, controlling the size and degree of an internal lattice structure that is modified into transition structures by the transition generation engine 110.

As noted herein, transition zones may refer to portions of the internal lattice structure 222 that the transition generation engine 110 determines to modify into transition structures (e.g., as determined, controlled, or selected based on the transition value 310). To modify a determined transition zone, e.g., the portions of the internal lattice structure 222 defined and determined through the transition value 310, the transition generation engine 110 may apply the secondary SDF 320. The secondary SDF 320 may refer to any SDF through which internal lattice geometry is modified to generate transition structures.

In that regard, the secondary SDF 320 may transform the determined portions of the internal lattice structure 222 that form transition zone, e.g., by thickening or otherwise altering the geometric structure an original lattice structure of the transition zone. The secondary SDF 320 itself may also be defined, represented, or implemented as an SDF, and the transition generation engine 110 may generate transition structures by applying SDFs (e.g., the secondary SDF 320) to SDFs (e.g., the SDF that represents the portion of the internal lattice structure 222 defined by the transition distance 310). Put another way, the transition generation engine 110 may generate transition structures through function-to-function computational processes. In the example shown in FIG. 3, the transition generation engine 110 applies the secondary SDF 320 to the transition zone determined for the internal lattice structure 222, doing so to form the transition structure 230 shown in FIG. 3.

Note that the secondary SDF 320 applied by the transition generation engine 110 may transform the lattice geometry of different portions of a transition zone differently. For portions of the transition zone that are closer in distance (e.g., more proximate) to an external surface, the transition generation engine 110 may modify the geometric structure of lattice elements in such portions to a greater degree than for lattice elements in other portions of the transition further in distance from the external surface. As one example shown in FIG. 3, the secondary SDF 320 applied by the transition generation engine 110 may be quadratic in differential (also referred to herein as “in difference”) for a first portion 330 of a transition zone along the transition distance 310 closest to the external surface 220, and may be linear in differential for a second portion 340 along the transition distance 310 further from the external surface 220 than the first portion 330.

Quadratic differences in the secondary SDF 320 for the first portion 330 of a transition zone may accelerate the transformation (e.g., thickening) of a geometric structure of the internal lattice structure 222 closer to the external surface 220. Doing so may improve the structural integrity of generated transition structures, allowing for lattice beams or other elements to thicken into a suitable structure to adequately join with the external surface 220 in order to support requisite mechanical strength and geometric integrity requirements that thinner lattice beams may be incapable of providing. Linear differences in the secondary SDF 320 for the second portion 340 of a transition zone may provide a more gradual transformation or blending as the transition zone meets other portions of an internal lattice structure 222 not modified by the secondary SDF 320. In doing so, the transition generation engine 110 may ensure a smoother transition to the regular geometry of the internal lattice structure 222, which may reduce pinch points or jagged transitions that can cause improper or undesired part properties.

The transition generation engine 110 may split a transition zone into any number of portions by which to apply the varying differentials of the secondary SDF 320. In some implementations, such partitioning of transition zones (e.g., the partitioning parameters to define the first portion 330 and second portion 340) may be defined as part of or within the secondary SDF 320 itself, or may be otherwise specified as separate transition parameters distinct from the secondary SDF 320. In some instances, the range, distance, or boundaries of the first portion 330 and the second portion 340 may be defined based on express distance values (e.g., the first portion 330 defined within 5.5 centimeters from the external surface and the second portion 340 covering the transition zone from 5.5 centimeters from the external surface 220 to the 10.1 centimeter value of the transition distance 310), as computational expressions (e.g., the first portion 330 defined as 15% of the total transition zone that is closest in distance to the external surface 220 and the second portion 340 as the remaining portion of the transition zone), or based on lattice parameter definitions. For example, the first portion 330 along the transition distance 310 (in which the secondary SDF 320 is quadratic) may be defined as being within a single unit cell distance from the external surface 220. In this instance, the second portion 340 along the transition distance 310 in which the secondary SDF 320 is linear may be the remaining portion of a transition zone beyond the single unit cell distance from the external surface 220.

While quadratic and linear differences are described herein as illustrative examples by which the transition generation engine 110 may apply the secondary SDF 320 to transform a transition zone of an internal lattice structure 222, any variance in SDF differentials for various partitions of a transition zone are contemplated herein. The transition generation engine 110 may split a transition zone into any number of portions (e.g., three partitions, with a first portion closest to the external surface 220 transformed by an SDF differential that is greater than quadratic in degree, a second portion transformed by an SDF differential that is quadratic in degree, and a third portion furthest from the external surface 220 transformed by an SDF differential linear in degree). Numerous other differential combinations and possibilities are contemplated herein.

As noted herein, transition parameters may be specified via user input. As such, the transition distance 310, the secondary SDF 320, the first portion 330 along the transition distance 310 closest to the external surface 220 at which the secondary SDF 320 is quadratic, the second portion 340 along the transition distance 310 further from the external surface 220 than the first portion at which the secondary SDF 320 is linear, or any combination thereof, may be specified via user input. Additionally or alternatively, the transition generation engine 110 may determine or extract any number of transition parameters from user inputs. As one example, the transition generation engine 110 may create the secondary SDF 320 from geometry parameters or definitions provided via user input.

In any of the ways described herein, the transition generation engine 110 may modify portions of internal lattice structures to form transition structures. Modified transition zones may be proximate to external surfaces that enclose the internal lattice structures, and the definition and transformation of such transition zones may be controlled through any number of transition parameters, including transition distances, secondary SDF definitions and more. With the generation of transition structures through application of secondary SDFs, lattice designs (including internal lattice structures and transition structures) may be represented as SDFs whereas the external surfaces, CAD bodies, and other CAD object elements may be represented as faced meshes, boundary representations, or in various other CAD-supported formats. CAD objects that include generated transition structures may undergo further processing in support of eventual physical manufacture. Some example processing features supported by the present disclosure are described next.

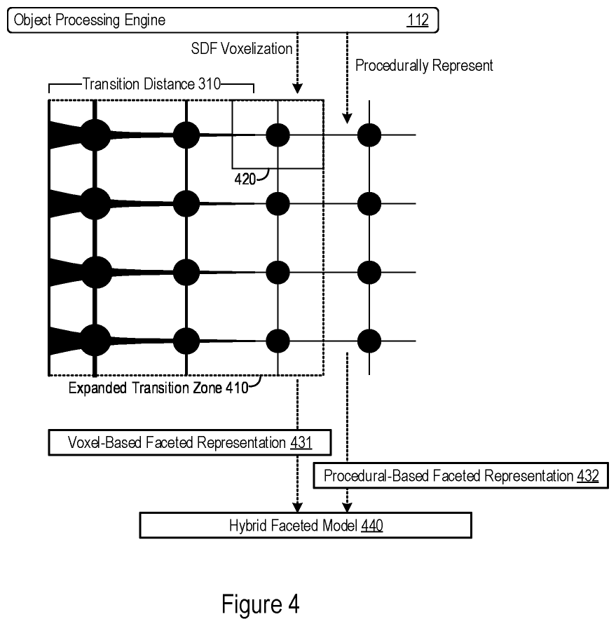

FIG. 4 shows example processing of a CAD object that includes a generated transition structure to generate a hybrid faceted model for the CAD object. An object processing engine 112 may provide any of the CAD object processing features described herein, and may thus process CAD objects comprising transition structures generated by the transition generation engine 110. In the example shown in FIG. 4, the object processing engine 112 may process a CAD object 210 that includes the transition structure 230 generated with the transition parameters described for FIG. 3, such as the transition distance 310 and secondary SDF 320.

In processing CAD objects that include generated transition structures, the object processing engine 112 may convert the internal lattice structure 222 and the transition structure 230 into a faceted model (e.g., a triangular mesh or any other CAD representation to be used in support of physical part manufacture based on the CAD object 210). While mesh generation and conversion techniques exist to generate faceted models from lattice designs, conventional techniques such as marching cubes and other voxelization processes may be inefficient and yield complex, data-intensive meshes, including for repeating designs like lattice structures. Procedural-based faceted representations may provide a relatively more compact, data-efficient representations of specific geometries (such as lattice beams), but may be limited to specific geometries, and thus inapplicable to the transformed geometry of generated transition structures of CAD objects or other irregular geometries.

In processing CAD objects into faceted models, the object processing engine 112 may generate hybrid faceted models, and may do so by selectively utilizing voxel-based faceted representations and procedural-based faceted representations to reduce model sizes and complexity, while maintaining mesh accuracy for generated lattice meshes. To do so, the object processing engine 112 may divide a lattice design of a CAD object (which includes generated transition structures to blend lattice structures to join with external surfaces) into different regions. The divided regions may include a first region for which to apply voxelization techniques (e.g., marching cubes) to generate a voxel-based faceted representation as well as a second region in which procedural-based faceted representations can be utilized (e.g., regular patterns of lattice beams, lattice balls, and other standard or repeating geometric elements that form a lattice design).

While partitioning by transition zones and non-transition zones may be one possibility of dividing an internal lattice structure for mesh generation, such a splitting may cause abrupt mesh transitions that can occur within a given unit cell of a lattice design when different representation techniques are used. Such abrupt transitions in meshing may cause unintended part deformations or jagged geometries that impact the accuracy, aesthetic, and structural effectiveness of physical parts manufactured according to such models. The object processing engine 112 may address such issues by determining an expanded transition zone for which to apply voxelization techniques.

In some implementations, the object processing engine 112 may determine an expanded transition zone for a CAD object as any unit cells of a lattice design with at least a portion of the unit cell modified by secondary SDFs used to generate transition structures of a CAD object. In other instances, the object processing engine 112 may determine an expanded transition zone for a CAD object as each of the unit cells within a transition zone, including any unit cells of a lattice design that are partially in the transition zone and partially outside the transition zone. By determining expanded transition zones, the object processing engine 112 may ensure that no unit cell of a repeating lattice design is meshed using multiple different techniques. Accordingly, smoother transitions between voxel-based faceted representations and procedural-based voxel representations can occur at inter-unit cell boundaries instead of as intra-unit cell mesh transitions.

An example of an expanded transition zone determined by the object processing engine 112 is shown in FIG. 4 through the expanded transition zone 410. To explain further, the object processing engine 112 may determine a transition zone that extends from an external surface up to the transition distance 310, and such a transition zone may be modified into a generated transition structure for the lattice design of the CAD object. Transition structures generated in a transition zone (which extends from an external surface through a distance within the internal lattice structure up to the transition distance 310) may only partially modify some lattice unit cells of an internal lattice structure, such as the unit cell 420 shown in FIG. 4. Note that only a portion of one of the lattice beams in the unit cell 420 of FIG. 4 is within the transition distance 310 from an external surface, and thus the lattice ball and other lattice beams in the unit cell 420 are not modified to generate a transition structure for the lattice design of the CAD object. Nonetheless, the object processing engine 112 may determine that the expanded transition zone 410 includes the entirety of the unit cell 420 since at least a portion of the unit cell 420 is within the transition distance 310 from an external surface, and thus modified in transition structure generations for the CAD object. As seen in FIG. 4, the object processing engine 112 may determine the expanded transition zone 410 such the boundary of the expanded transition zone 410 lies on inter-unit cell boundaries.

Upon determination of the expanded transition zone 410, the object processing engine 112 may generate a hybrid faceted model by applying different faceting techniques to the expanded transition zone 410 and the remaining portion of an internal lattice structure not within the expanded transition zone 410. To generate a faceted model of a CAD object 210, the object processing engine 112 may perform an SDF voxelization process (e.g., marching cubes) for the expanded transition zone 410 of the CAD object 210. In applying the SDF voxelization process to the expanded transition zone 410, the object processing engine 112 may generate a voxel-based faceted representation 431 of the geometry of the expanded transition zone 410, which may include any number of generated transition structures for blending a lattice design to external surfaces.

In generating a faceted model for a CAD object, the object processing engine 112 may also utilize procedural-based faceted representations to represent portions of an internal lattice structure outside of the expanded transition zone 410. Such portions outside of the expanded transition zone 410 may be such that no portion of a unit cell of the lattice design is modified by the secondary SDF 320 in generating the transition structures of the CAD object. An example of such is shown in FIG. 4 through the procedural-based faceted representation 432 generated for portions of an internal lattice structure outside of the expanded transition zone. Since such portions of the internal lattice structure do not include any lattice unit cells modified in generation of transition structures, a procedural-based faceted representation may more efficiently represent the regular geometric elements of the lattice design, e.g., with fewer triangles or other mesh primitives as compared to voxel-based meshing processes.

The object processing engine 112 may generate a hybrid faceted model by combining the procedural-based faceted representation 432 of the portions of an internal lattice structure outside of the expanded transition zone 410 and the voxel-based faceted representation 431 of the geometry of the expanded transition zone 410 generated from the SDF voxelization process performed for the expanded transition zone 410. Such an example is shown in FIG. 4 through the hybrid faceted model 440. The hybrid faceted model 440 may include less mesh elements (e.g., a substantially lesser number of triangles) than a faceted model generated through brute force voxelization of a lattice design that includes generated transition structures. Moreover, the hybrid faceted model 440 may include smoother transitions, located strategically at unit cell boundaries, as compared to voxelization of only the transition structures generated for a CAD object. Procedural-based faceted representation of repeating geometric elements in the hybrid faceted model 440 may provide an efficient representation mechanism for lattice beams, balls, and other regular geometric elements. As such, hybrid faceted models processed by the object processing engine 112 may provide an efficient, accurate, elegant, and smooth representation of CAD objects comprising generated transition structures.

In any of the ways described herein, the object processing engine 112 may process CAD objects to generate hybrid faceted models in support of the manufacture of physical parts based on CAD object designs.

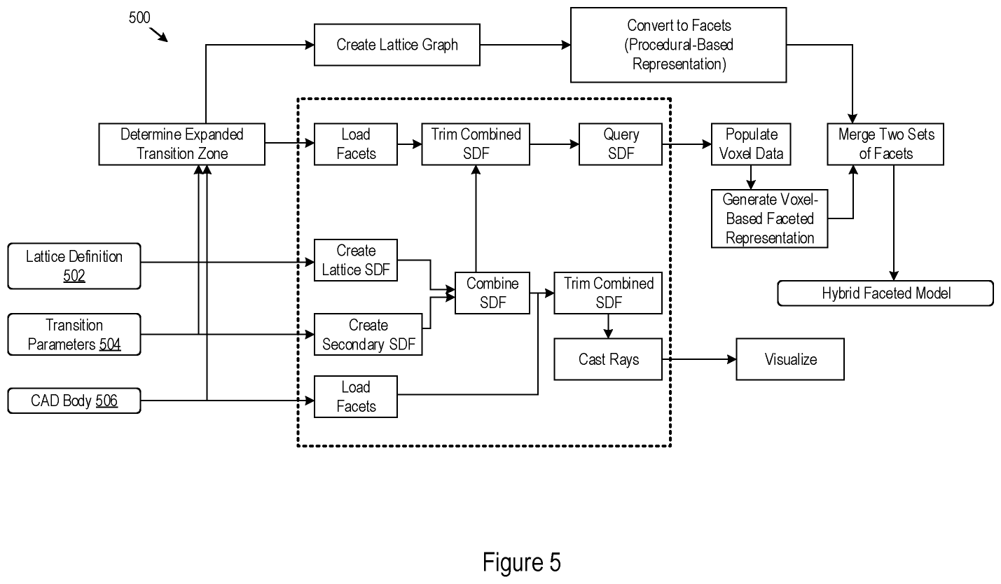

FIG. 5 shows an example of a processing pipeline 500 for generation and processing of transition structures for internal lattice structures of a CAD object. A computing system may implement or perform any part of the processing pipeline 500 to provide any of the features described herein. The transition generation engine 110, the object processing engine 112, or a combination of both, may implement, support, perform, or provide any of the features described with respect to the processing pipeline 500 shown in FIG. 5.

The inputs that the processing pipeline 500 may receive include a lattice definition 502, transition parameters 504, and a CAD body 506. The lattice definition 502 may include any parameters or data that defines a lattice, and may thus include unit cell parameters such as width, height, area, or volume parameters, geometric element definitions (e.g., beam widths, ball radii values, etc.), or any other parameters that may otherwise define a lattice design. The transition parameters 504 may include any parameters or data applicable to the generation of transition structures for an internal lattice structure defined by the lattice definition 502. The transition parameters 504 may include transition distances, transition geometry definitions, differential region breakdowns, or parameter values for quadratic or linear differences of secondary SDFs, and more. The CAD body 506 may include any definition of a CAD sub-part or element to infill with a lattice design according to the lattice definition 502, and thus may specify a 3D object (e.g., a faceted mesh) for which to infill with an internal lattice structure and corresponding transitions structures.

The processing pipeline 500 may process the inputs differently based on whether to visualize the CAD body with a generated lattice infill or to generate a faceted model for the CAD body with the generated lattice infill. For visualizations, the processing pipeline 500 may be performed using the entire CAD body (with infilled lattice design) and lazy local evaluation to visualize respective elements of the lattice design an CAD body. As an illustrative sequence for visualization, the processing pipeline 500 may include creating a lattice SDF from the lattice definition 502, which may include generating an SDF representation that represents an internal lattice structure based on the lattice definition 502 inputs. In support of transition structure generation, the processing pipeline 500 may include creating a secondary SDF based on the transition parameters 504, and the created secondary SDF may include quadratic differences and linear differences for different portions of a transition zone (the transition zone may be defined by an input transition distance).

The processing pipeline 500 may also include combining the lattice SDF and the secondary SDF to form a lattice infill for the CAD body 506 that includes transition structures generated via the secondary SDF. Such a combination of SDFs may be performed by applying the secondary SDF to the portions of the lattice SDF that define the transition zone, and such an application may generate transition structures as described herein. The combined SDF may thus represent (via distance functions) a lattice design with transition structures modified for selected portions of an internal lattice design.

In the example visualization sequence, the processing pipeline 500 may also include loading facets of the CAD body 506 to define the external boundary at which the generated infill lattice ends, trimming the combined SDF at the boundaries defined by the loaded facets of the CAD body 506, and then performing ray casting to visualize the CAD body 506 that includes the generated lattice infill (including generated transition structures). In such a manner, the processing pipeline 500 may support visualization of a CAD body 506 that includes transition structures transformed from an internal lattice structure defined by the lattice definition 502, and such transition structure generations performed through application of a secondary SDF accessed or created based on the transition parameters 504

For generation of a faceted model for the CAD body 506, the processing pipeline 500 may perform a different flow (at least in part). The processing pipeline 500 may include various steps to generate a procedural-based faceted representation and a voxel-based faceted representation to combine into a hybrid faceted model. As an illustrative sequence for generation of a hybrid faceted model for a CAD body 506 with a lattice infill generated based on the lattice definition 502 and transition parameters 504, the processing pipeline 500 may include determining an expanded transition zone for the CAD body 506, doing so based on the external surfaces defined by the CAD body 506, transition distance(s) specified in the transition parameters 504, and unit cell definitions specified in the lattice definition 502. Determination of the expanded transition zone may be consistent with any of the ways described herein, e.g., in a consistent manner as described for determination of the expanded transition zone 410 described with reference to FIG. 4. The processing pipeline 500 may also include creating a lattice graph for portions of an internal lattice structure outside of the transition zone and converting such portions into facets as procedural-based faceted representations.

Generation of the faceted model through the processing pipeline 500 may also include loading facets of the CAD body 506 and trimming a combined SDF of the secondary SDF applied to the lattice SDF. Such a trimming may be applied specifically to filter the CAD body 506 such that only the geometric elements of the expanded transition zone are defined (e.g., limiting or filtering application/instantiation of the combined SDF only to the expanded transition zone). Then, the processing pipeline 500 may include querying this trimmed SDF to determining/instantiating a geometric representation of the expanded transition zone that includes transition structures generated through application of the secondary SDF. The processing pipeline 500 may include populating voxel data resulting from querying of the trimmed SDF (e.g., generating a voxel-based representation of the geometry of the expanded transition zone as defined by the combined SDF (trimmed). Then, the processing pipeline 500 may include generating a faceted mesh of the expanded transition zone as the voxel-based faceted representation, for example doing so through marching cubes. With both voxel-based and procedural-based meshes generated, the processing pipeline 500 may include merging the two sets of facets to form the hybrid faceted model.

The processing pipeline 500 may include some steps for which execution can be effectively performed through parallelization or via graphics processing unit (GPU) architectures. In some implementations, a computing system may assign a selected subset of the processing pipeline 500 for execution through GPUs or other similar processing units, including specifically the steps of the processing pipeline 500 in the dotted rectangle shown in FIG. 5. Other steps not in the dotted rectangle may be more suitable performed through central processing units (CPUs) or similar architectures. Through such execution assignments, a computing system may perform any combination of the lattice infill, transition structure generation, and CAD object processing processes described herein with increased efficiency and execution speed.

Many of the lattice transition generation features described herein have been presented through illustrative examples included in various figures, and the transition generation engine 110 or the object processing engine 112 may implement any combination of any of the lattice transition generation features described herein.

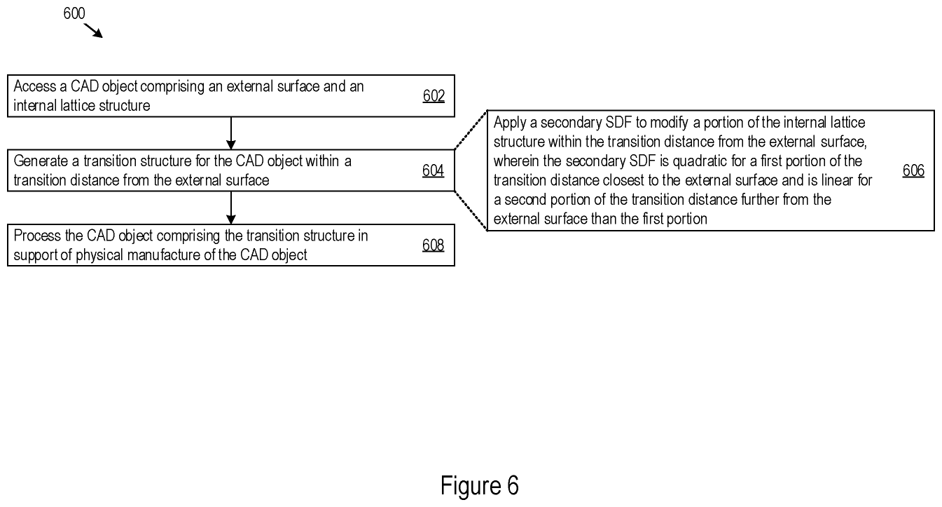

FIG. 6 shows an example of logic 600 that a system may implement to support generation of transition structures for internal lattice structures of CAD objects. For example, the computing system 100 may implement the logic 600 as hardware, executable instructions stored on a machine-readable medium, or as a combination of both. The computing system 100 may implement the logic 600 via the transition generation engine 110 and the object processing engine 112, through which the computing system 100 may perform or execute the logic 600 as a method to support generation of transition structures for internal lattice structures of CAD objects. The following description of the logic 600 is provided using the transition generation engine 110 and the object processing engine 112 as examples. However, various other implementation options by computing systems are possible.

In implementing the logic 600, the transition generation engine 110 may access a CAD object comprising an external surface and an internal lattice structure (602). The internal lattice structure may be represented through repeating unit cells of a lattice design, and the internal lattice structure 222 may be represented as an SDF. In implementing the logic 600, the transition generation engine 110 may also generating a transition structure for the CAD object within a transition distance from the external surface (604). To do so, the transition generation engine 110 may apply a secondary SDF to modify a portion of the internal lattice structure within the transition distance from the external surface, wherein the secondary SDF is quadratic for a first portion along the transition distance closest to the external surface and is linear for a second portion along the transition distance further from the external surface than the first portion (606). In implementing the logic 600, the object processing engine 112 may process the CAD object comprising the transition structure in support of physical manufacture of the CAD object (608), doing so in any of the ways described herein.

The logic 600 shown in FIG. 6 provides an illustrative example by which a computing system 100 may support generation and processing of transition structures for internal lattice structures of CAD objects according to the present disclosure. Additional or alternative steps in the logic 600 are contemplated herein, including according to any of the various features described herein for the transition generation engine 110, the object processing engine 112, and any combinations thereof.

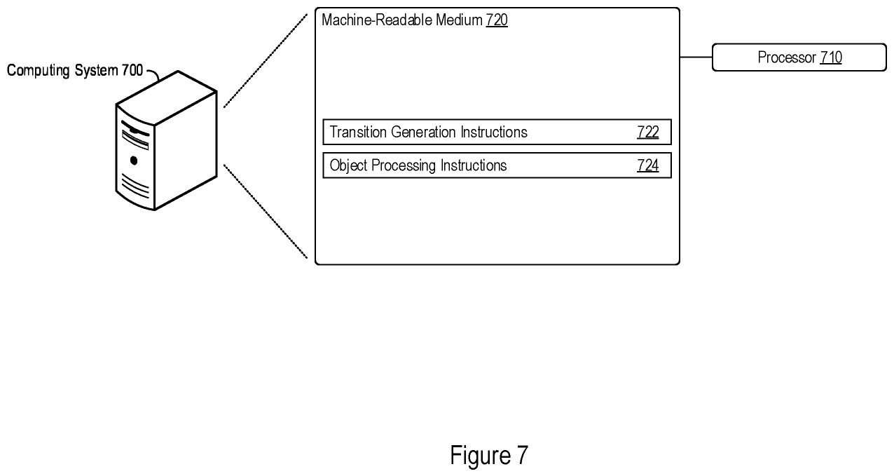

FIG. 7 shows an example of a computing system 700 that supports generation of transition structures for internal lattice structures of CAD objects. The computing system 700 may include a processor 710, which may take the form of a single or multiple processors. The processor(s) 710 may include a central processing unit (CPU), microprocessor, or any hardware device suitable for executing instructions stored on a machine-readable medium. The computing system 700 may include a machine-readable medium 720. The machine-readable medium 720 may take the form of any non-transitory electronic, magnetic, optical, or other physical storage device that stores executable instructions, such as the transition generation instructions 722 and the object processing instructions 724 shown in FIG. 7. As such, the machine-readable medium 720 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 700 may execute instructions stored on the machine-readable medium 720 through the processor 710. Executing the instructions (e.g., the transition generation instructions 722 and/or the object processing instructions 724) may cause the computing system 700 to perform any of the lattice transition generation features described herein, including according to any of the features of the transition generation engine 110, the object processing engine 112, or combinations of both.

For example, execution of the transition generation instructions 722 by the processor 710 may cause the computing system 700 to access a computer-aided design (CAD) object comprising an external surface and an internal lattice structure represented through repeating unit cells of a lattice design. The internal lattice structure may be represented as a signed distance field, as described herein. Execution of the transition generation instructions 722 may further cause the computing system 700 to generate a transition structure for the CAD object within a transition distance from the external surface, including by applying a secondary SDF to modify a portion of the internal lattice structure within the transition distance from the external surface. The applied secondary SDF may be quadratic for a first portion along the transition distance closest to the external surface and may be linear for a second portion along the transition distance further from the external surface than the first portion. Execution of the object processing instructions 724 by the processor 710 may cause the computing system 700 to process the CAD object comprising the transition structure in support of physical manufacture of the CAD object, doing so in any of the ways described herein.

Any additional or alternative lattice transition generation features as described herein may be implemented via the transition generation instructions 722, object processing instructions 724, or a combination of both.

The systems, methods, devices, and logic described above, including the transition generation engine 110 and the object processing engine 112, may be implemented in many different ways in many different combinations of hardware, logic, circuitry, and executable instructions stored on a machine-readable medium. For example, the transition generation engine 110, the object processing engine 112, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the transition generation engine 110, the object processing engine 112, or combinations thereof.

The processing capability of the systems, devices, and engines described herein, including the transition generation engine 110 and the object processing engine 112, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
accessing a computer-aided design (CAD) object comprising an external surface and an internal lattice structure represented through repeating unit cells of a lattice design, the internal lattice structure represented as a signed distance field (SDF);
generating a transition structure for the CAD object within a transition distance from the external surface, including by:
applying a secondary SDF that is different from the SDF that represents the internal lattice structure to modify a portion of the internal lattice structure within the transition distance from the external surface, wherein the secondary SDF is quadratic for a first portion along the transition distance closest to the external surface and is linear for a second portion along the transition distance further from the external surface than the first portion; and
processing the CAD object comprising the transition structure in support of physical manufacture of the CAD object.

2. The method of claim 1, wherein the first portion along the transition distance in which the secondary SDF is quadratic is within a single unit cell distance from the external surface and wherein the second portion along the transition distance in which the secondary SDF is linear is beyond the single unit cell distance from the external surface.

3. The method of claim 1, wherein applying the secondary SDF to modify the portion of the internal lattice structure within the transition distance from the external surface comprises applying the secondary SDF to the SDF that represents the portion of the internal lattice structure to obtain the transition structure.

4. The method of claim 1, wherein processing the CAD object comprising the transition structure in support of physical manufacture of the CAD object comprises:
generating a faceted model of the CAD object, including by performing an SDF voxelization process for an expanded transition zone of the CAD object, wherein the expanded transition zone comprises any unit cells of the lattice design with at least a portion modified by the secondary SDF in generating the transition structure.

5. The method of claim 4, further comprising utilizing a procedural-based faceted representation to represent portions of the internal lattice structure outside of the expanded transition zone in which no portion of a unit cell of the lattice design is modified by the secondary SDF in generating the transition structure.

6. The method of claim 5, comprising generating a hybrid faceted model as the faceted model of the CAD object, including by combining the procedural-based faceted representation of the portions of the internal lattice structure outside of the expanded transition zone and a voxel-based faceted representation of the expanded transition zone generated from the SDF voxelization process performed for the expanded transition zone.

7. The method of claim 1, wherein the transition distance, the secondary SDF, the first portion along the transition distance closest to the external surface at which the secondary SDF is quadratic, the second portion along the transition distance further from the external surface than the first portion at which the secondary SDF is linear, or any combination thereof, are specified via user input.

8. A system comprising:
a transition generation engine configured to:
access a computer-aided design (CAD) object comprising an external surface and an internal lattice structure represented through repeating unit cells of a lattice design, the internal lattice structure represented as a signed distance field (SDF); and
generate a transition structure for the CAD object within a transition distance from the external surface, including by:
applying a secondary SDF that is different from the SDF that represents the internal lattice structure to modify a portion of the internal lattice structure within the transition distance from the external surface, wherein the secondary SDF is quadratic for a first portion along the transition distance closest to the external surface and is linear for a second portion along the transition distance further from the external surface than the first portion; and
an object processing engine configured to process the CAD object comprising the transition structure in support of physical manufacture of the CAD object.

9. The system of claim 8, wherein the first portion along the transition distance in which the secondary SDF is quadratic is within a single unit cell distance from the external surface and wherein the second portion along the transition distance in which the secondary SDF is linear is beyond the single unit cell distance from the external surface.

10. The system of claim 8 wherein the transition generation engine is configured to apply the secondary SDF to modify the portion of the internal lattice structure within the transition distance from the external surface by applying the secondary SDF to the SDF that represents the portion of the internal lattice structure to obtain the transition structure.

11. The system of claim 8, wherein the object processing engine is configured to process the CAD object comprising the transition structure in support of physical manufacture of the CAD object by:
generating a faceted model of the CAD object, including by performing an SDF voxelization process for an expanded transition zone of the CAD object, wherein the expanded transition zone comprises any unit cells of the lattice design with at least a portion modified by the secondary SDF in generating the transition structure.

12. The system of claim 11, wherein the object processing engine is further configured to utilize a procedural-based faceted representation to represent portions of the internal lattice structure outside of the expanded transition zone in which no portion of a unit cell of the lattice design is modified by the secondary SDF in generating the transition structure.

13. The system of claim 12, wherein the object processing engine is configured to generate a hybrid faceted model as the faceted model of the CAD object, including by combining the procedural-based faceted representation of the portions of the internal lattice structure outside of the expanded transition zone and a voxel-based faceted representation of the expanded transition zone generated from the SDF voxelization process performed for the expanded transition zone.

14. The system of claim 8, wherein the transition distance, the secondary SDF, the first portion along the transition distance closest to the external surface at which the secondary SDF is quadratic, the second portion along the transition distance further from the external surface than the first portion at which the secondary SDF is linear, or any combination thereof, are specified via user input.

15. A non-transitory machine-readable medium comprising instructions that, when executed by a processor, cause a computing system to:
access a computer-aided design (CAD) object comprising an external surface and an internal lattice structure represented through repeating unit cells of a lattice design, the internal lattice structure represented as a signed distance field (SDF);
generate a transition structure for the CAD object within a transition distance from the external surface, including by:
applying a secondary SDF that is different from the SDF that represents the internal lattice structure to modify a portion of the internal lattice structure within the transition distance from the external surface, wherein the secondary SDF is quadratic for a first portion along the transition distance closest to the external surface and is linear for a second portion along the transition distance further from the external surface than the first portion; and
process the CAD object comprising the transition structure in support of physical manufacture of the CAD object.

16. The non-transitory machine-readable medium of claim 15, wherein the first portion along the transition distance in which the secondary SDF is quadratic is within a single unit cell distance from the external surface and wherein the second portion along the transition distance in which the secondary SDF is linear is beyond the single unit cell distance from the external surface.

17. The non-transitory machine-readable medium of claim 15, wherein the instructions, when executed, cause the computing system to apply the secondary SDF to modify the portion of the internal lattice structure within the transition distance from the external surface by applying the secondary SDF to the SDF that represents the portion of the internal lattice structure to obtain the transition structure.

18. The non-transitory machine-readable medium of claim 15, wherein the instructions, when executed, cause the computing system to process the CAD object comprising the transition structure in support of physical manufacture of the CAD object by:
generating a faceted model of the CAD object, including by performing an SDF voxelization process for an expanded transition zone of the CAD object, wherein the expanded transition zone comprises any unit cells of the lattice design with at least a portion modified by the secondary SDF in generating the transition structure.

19. The non-transitory machine-readable medium of claim 18, further comprising utilizing a procedural-based faceted representation to represent portions of the internal lattice structure outside of the expanded transition zone in which no portion of a unit cell of the lattice design is modified by the secondary SDF in generating the transition structure.

20. The non-transitory machine-readable medium of claim 19, wherein the instructions, when executed, cause the computing system to generate a hybrid faceted model as the faceted model of the CAD object, including by combining the procedural-based faceted representation of the portions of the internal lattice structure outside of the expanded transition zone and a voxel-based faceted representation of the expanded transition zone generated from the SDF voxelization process performed for the expanded transition zone.
